(19) United States
(12) Patent Application Publication
(10) Pub. No.: US 2013/0101205 A1
(43) Pub. Date: Apr. 25, 2013

(54) LABEL DETECTING SYSTEM, APPARATUS AND METHOD THEREOF

(71) Applicants: WEN-WU WU, Shenzhen City (CN); MENG-ZHOU LIU, Shenzhen City (CN)

(72) Inventors: WEN-WU WU, Shenzhen City (CN); MENG-ZHOU LIU, Shenzhen City (CN)

(73) Assignees: HON HAI PRECISION INDUSTRY CO., LTD., Tu-Cheng (TW); HON FU JIN PRECISION INDUSTRY (Shenzhen) CO., LTD., Shenzhen City (CN)

(21) Appl. No.: 13/418,363

(22) Filed: Mar. 13, 2012

(30) Foreign Application Priority Data
Oct. 25, 2011 (CN) 201110327676.8

(51) Int. Cl. G06K 9/00

(52) U.S. Cl. 382/145

(57) ABSTRACT

The present disclosure provides a label detecting system, apparatus and a detecting label method for the label detecting system. The method includes steps whereby an image processing function for the image of the circuit board under test to obtain a binary image of the circuit board takes place, dividing the binary image of the circuit board into a number of areas and scanning the binary image of the circuit board, performing a generalization and correlation analysis between each area and the binary image of the standard label to obtain a matching value, acquiring a maximum and location information of the area associated with a maximum, comparing the maximum with two threshold values to detect a result of the determination as to the correctness of the location information of the area as compared to that of the standard label, and displaying the result.

### BACKGROUND

1. Technical Field

The disclosure relates to label detecting technology and, more particularly, to a label detecting system, a label detecting apparatus and a label detecting method adapted for the label detecting apparatus.

2. Description of Related Art

A circuit board of a computer normally has an identification label adhered to it. In the course of producing the computer, the label is needed on the circuit board, and it should be located in a correct position on the circuit board, the contents of the label should be correct for that particular circuit board, showing, for example, a serial number of the label and other relevant information. In related art, a conventional detecting label method directly compares a circuit board under test with a standard circuit board to investigate a position of a label on the circuit board under test, where the standard circuit board is properly labeled. However, the conventional detecting label method of comparing two whole boards is cursory and inaccurate.

Therefore, what is needed is a label detecting system to overcome the described shortcoming

### BRIEF DESCRIPTION OF THE DRAWINGS

FIG. 1 is a block diagram of a label detecting system in accordance with an exemplary embodiment.

FIG. 2 is a block diagram of a label detecting apparatus of the label detecting system of FIG. 1.

FIG. 3 is a schematic view of detecting a label of the label detecting system of FIG. 1.

FIG. 4 is a schematic view of determining the position of a label on a circuit board under test of the label detecting system of FIG. 1.

FIGS. 5 and 6 are a flowchart of detecting a label method adapted for the label detecting system of FIG. 1.

### DETAILED DESCRIPTION

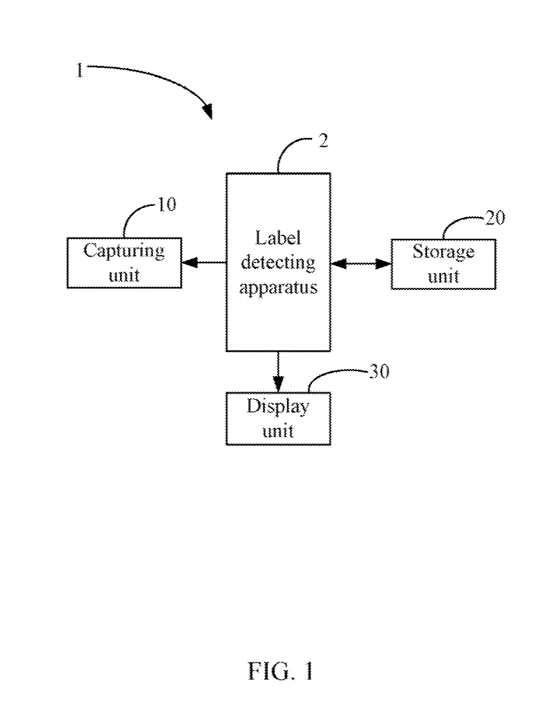

FIG. 1 is a block diagram of a label detecting system in accordance with an exemplary embodiment. The label detecting system 1 is utilized for detecting and investigating the position of a label on a circuit board under test, and reading the actual label for the correctness of certain information shown on the label. The label detecting system 1 includes a label detecting apparatus 2, a capturing unit 10, a storage unit 20, and a display unit 30. The label detecting apparatus 2 is electrically connected with the capturing unit 10, the storage unit 20, and the display unit 30. The capturing unit 10 is configured to capture an image, for example, take a photo of the circuit board under test. The display unit 30 is configured to display information.

The storage unit 20 is configured to pre-store a binary image of a standard label, location information of the standard label on a standard circuit board, and two threshold values, wherein a first threshold value is closer to one and a second threshold value is closer to zero. The standard label is adhesively attached in a proper position on the standard circuit board which has a same shape as the circuit board under test. The binary image of the standard label and the location information of the standard label on the standard circuit board may be obtained from other storage devices (not shown).

The binary image of the standard label and the location information of the standard label on the standard circuit board also can be obtained from the label detecting apparatus 2 according to an obtaining method as follows: the capturing unit 10 takes a photo of the standard circuit board, to which the standard label is adhesively attached in the proper position, to obtain an image of the standard circuit board, and the label detecting apparatus 2 performs an image processing function for the obtained image of the standard circuit board to obtain the binary image of the standard label and the location information of the standard label on the standard circuit board. The image processing function includes steps of: acquiring an image of the standard label from the image of the standard circuit board based on a profile algorithm, performing a gray processing function for the image of the standard label to obtain a gray image of the standard label, performing an adaptive binary processing function for the gray image of the standard label to obtain the binary image of the standard label, and performing a gray processing function for the image of the standard circuit board to obtain a gray image of the standard circuit board, performing an adaptive binary processing function for the gray image of the standard circuit board to obtain the binary image of the standard circuit board, and cutting out the standard label based on the binary image of the standard label from the binary image of the standard circuit board to obtain the location information of the standard label on the standard circuit board.

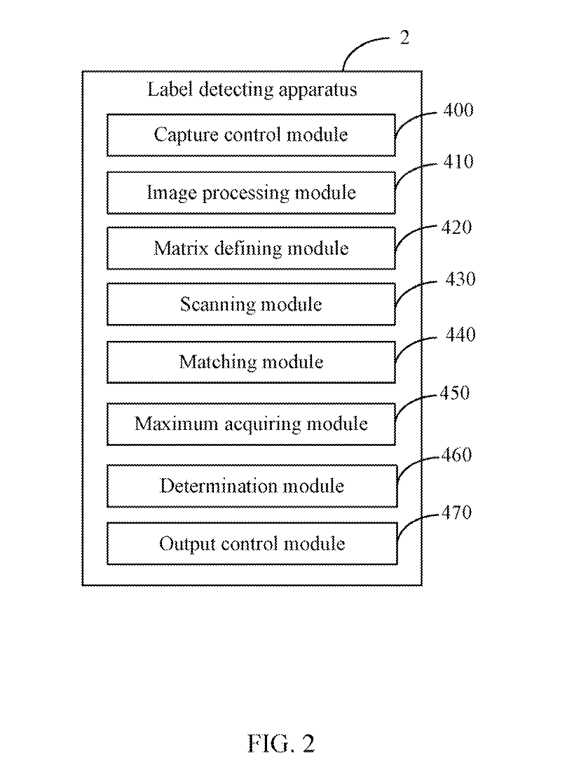

Referring to FIG. 2, the label detecting apparatus 2 includes a capture control module 400, an image processing module 410, a matrix defining module 420, a scanning module 430, a matching module 440, a maximum acquiring module 450, a determination module 460, and an output control module 470. The capture control module 410 is configured to control the capturing unit 10 to capture an image of the circuit board under test in response to user input, wherein the circuit board under test will have the correct, and the correctly-located, a label adhesively attached thereon. The image processing module 410 is configured to perform an image processing function for the image of the circuit board under test to obtain a binary image of the circuit board under test. For example, the image processing module 410 performs a gray processing function for the image of the circuit board under test to obtain a gray image and further performs an adaptive binary processing function for the gray image obtained, to achieve a binary image of the circuit board under test.

The matrix defining module 420 is configured to define a two-dimensional matrix according to the binary image of the circuit board under test and the binary image of the standard label, wherein a column N of the two-dimensional matrix is obtained according to a formula: N=N2−N1+1, where N2 represents a column of the binary image of the circuit board under test and N1 represents a column of the binary image of the standard label, and a row M of the two-dimensional matrix is obtained according to a formula: M=M2−M1+1, where M2 represents a row of the binary image of the circuit board under test and M1 represents a row of the binary image of the standard label.

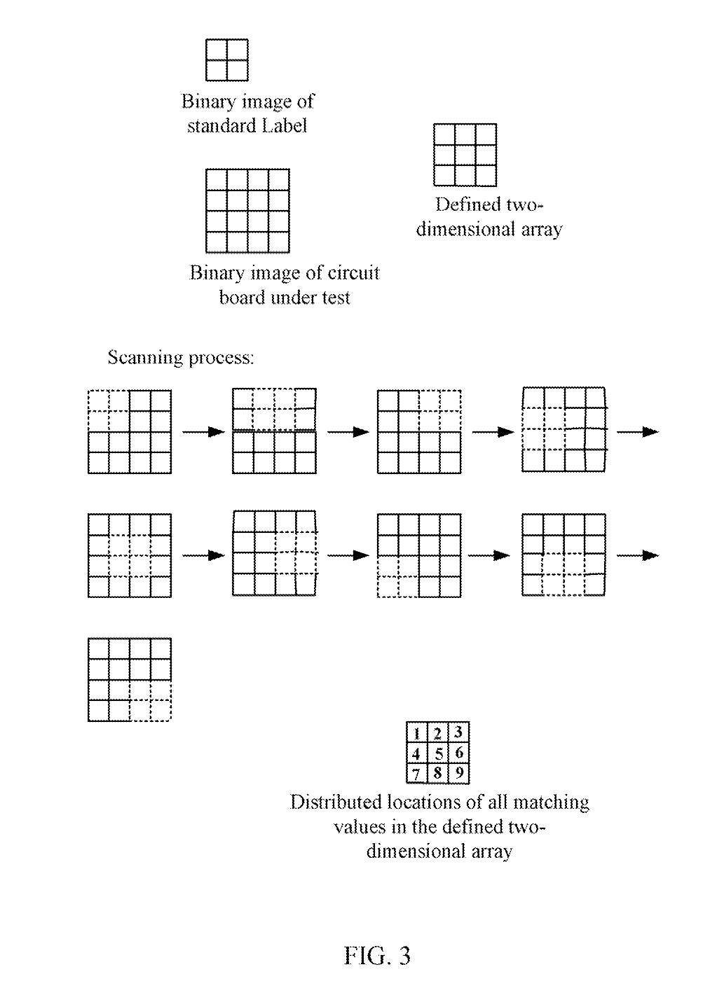

The scanning module 430 is configured to divide the binary image of the whole circuit board under test into a number of areas each of which has the same size as the standard label in binary form and scan the binary image of the circuit board under test by the binary image of the standard label, such as scanning the circuit board under test from the initial position as shown in FIG. 3. The matching module 440 is configured to perform a generalization and correlation analysis between each area and the binary image of the standard label to obtain a matching value and distribute all matching values in the defined two-dimensional matrix in order, such as from left to right. Each matching value is associated with a particular divided area. The maximum acquiring module 450 is configured to acquire a maximum from all matching values and location information for any particular area which is associated with the maximum. The area associated with the maximum may be or should be the area where a label is adhesively attached.

The determination module 460 is configured to determine whether the location information of the area associated with the maximum is similar to the actual location of the standard label in the binary image of the standard circuit board. When the location information of the area associated with the maximum is not similar, the output control module 470 is configured to control the display unit 50 to display a prompt or warning that a label on the circuit board under test is not in a proper position or that the circuit board under test is not labeled at all. When the location information of the area associated with the maximum is similar, the determination module 460 further compares the maximum with the two stored threshold values to detect a result concerning the actual position of the label on the circuit board under test. The output control module 470 further controls the display unit 50 to display the result of the determination.

FIG. 3 is a schematic view of detecting a label of the label detecting system of FIG. 1. In the embodiment, the binary image of the standard label is a two dimensional matrix including two columns and two rows, the binary image of the circuit board under test is a two dimensional matrix including four columns and four rows. Therefore, the matrix defining module 420 defines the two dimensional matrix so as to include three columns and three rows.

A scanning process performed by the scanning module 430 includes the steps of: scanning a matrix unit (the dotted lines shown in FIG. 3) in the binary image of the circuit board under test line by line from the initial position, and thereby scanning nine matrix units in the binary image of the circuit board under test. The matching module 440 performs a generalization and correlation analysis between each matrix unit and the binary image of the standard label to obtain a matching value and distributes nine matching values in the defined two-dimensional matrix. The maximum acquiring module 450 acquires a maximum from the nine matching values and location information of a matrix unit associated with the maximum, such as, for example, the ninth area.

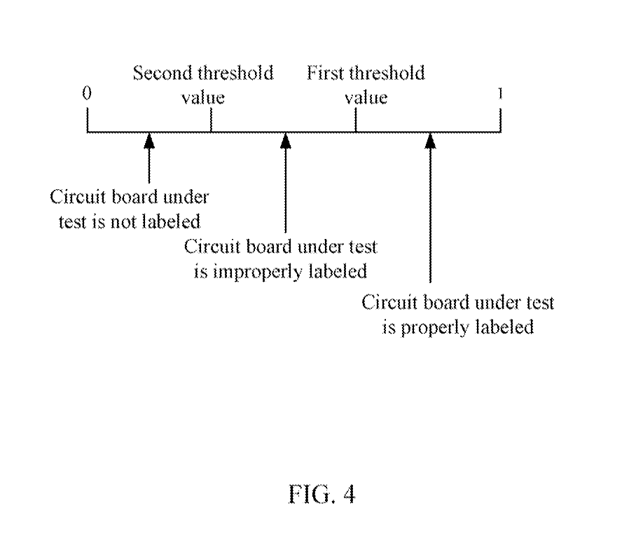

The determination module 460 determines whether the location information of the ninth area is similar to that of the standard label. Referring to FIG. 4, when the maximum is greater than the first threshold value, the result of the determination by determination module 460 is that the circuit board under test is properly labeled, that is, a label on the ninth area is adhered in the proper position on the circuit board under test. When the maximum is between the two threshold values, the result of the determination determined by the determination module 460 is that while the circuit board under test appears to be labeled, it is improperly labeled, in the sense that it is in the wrong position.

That is, a label which is on the ninth area is improperly adhered to the circuit board under test. When the maximum is less than the second threshold value, the result of the determination determined by the determination module 460 is that the circuit board under test is not labeled at all, that is, the circuit board under test does not include a label.

The storage unit 20 is further configured to store a plurality of serial numbers of a set of labels including the standard label. Each serial number corresponds to an individual circuit board under test. When the maximum is greater than the first threshold value, the image processing module 410 is further configured to perform a gray and binary processing function for the image of the label actually on the circuit board under test to obtain a binary image of the label and obtain a serial number of the actual label via a string segmentation algorithm, the determination module 460 is further configured to determine whether the serial number of the actual label has been stored in the storage unit 20, thereby determining whether the label is adhering to the proper circuit board. Therefore, the label detecting system 1 can quickly and correctly detect an incorrect label distribution on the circuit board under test.

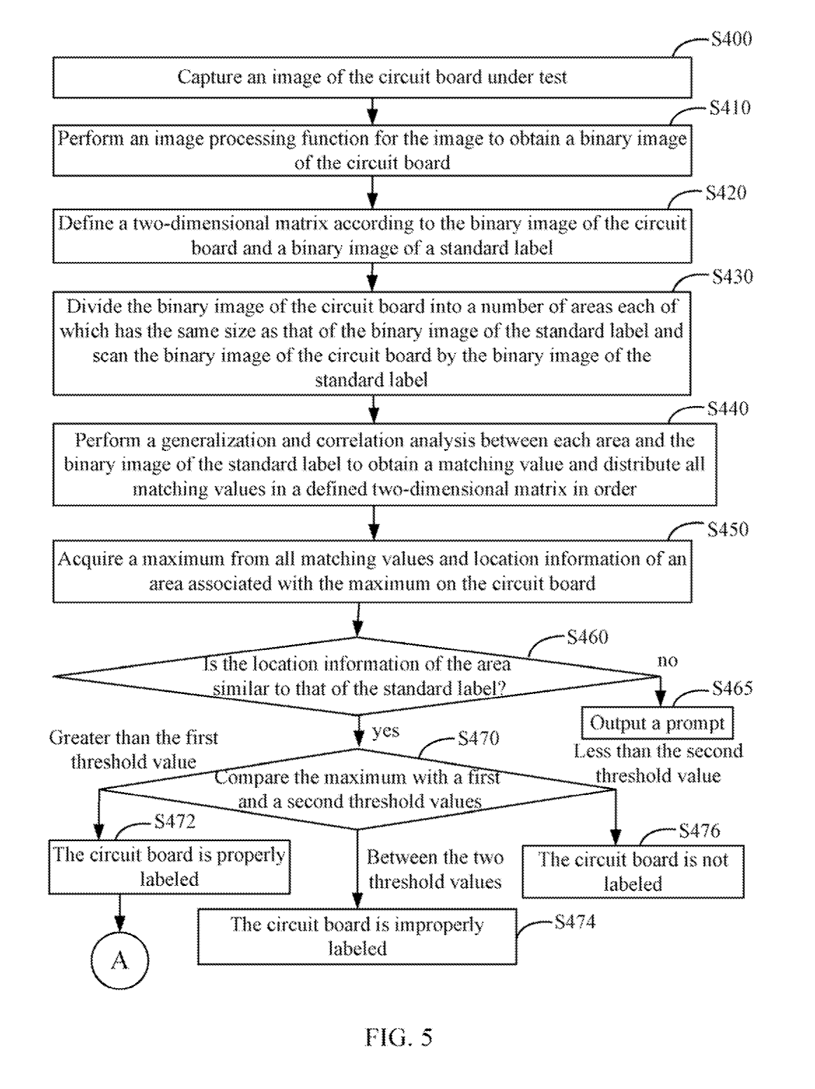

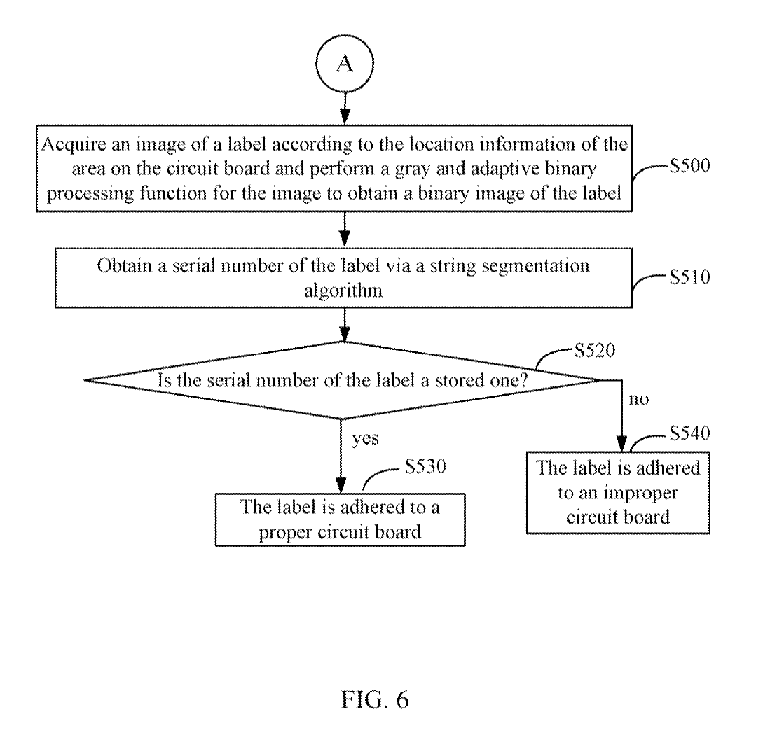

FIGS. 5 and 6 are a flowchart of detecting a label method adapted for the label detecting system of FIG. 1. In step S400, the capture control module 410 controls the capturing unit 10 to capture an image of the circuit board under test in response to user input. In step S410, the image processing module 410 performs an image processing function in relation to the image of the circuit board under test to obtain a binary image.

In step S420, the matrix defining module 420 defines a two-dimensional matrix according to the binary image of the circuit board under test and the binary image of the standard label.

In step S430, the scanning module 430 divides the binary image of the circuit board under test into a number of areas each of which has the same size as that of the binary image of the standard label and scans the binary image of the circuit board under test in the binary image of the standard label. In step S440, the matching module 440 performs a generalization and correlation analysis between each area after division and the binary image of the standard label to obtain a matching value and distributes all matching values in the defined two-dimensional matrix in order. In step S450, the maximum acquiring module 450 acquires a maximum from all matching values and location information of the particular area associated with the maximum on the circuit board under test.

In step S460, the determination module 460 determines whether the location information of the particular area associated with the maximum is similar to that of the standard label. In step S465, when the location information is not similar to that of the standard label in the binary image of the standard circuit board, the output control module 470 outputs a prompt or warning and controls the display unit 50 to display the prompt stating that the label on the circuit board under test is not adhering in a proper position or that the circuit board under test is not labeled at all. In step S470, when the location information of the area associated with the maximum is similar to that of the standard label, the determination module 460 further compares the maximum with the two threshold values.

In step S472, when the maximum is greater than a first threshold value of the two threshold values, the circuit board under test is determined to be properly labeled and to have a label in the correct location. In step S474, when the maximum is between the two threshold values, the circuit board under test is determined to be improperly labeled. In step S476, when the maximum is less than a second threshold value of the two threshold values, the circuit board under test is determined to be not labeled at all.

In step S500, when the maximum is greater than the first threshold value, the image processing module 410 performs a gray and binary processing function for the image of the label taken from the circuit board under test to obtain a binary image of the label. In step S510, the image processing module 410 determines a serial number of the actual label via a string segmentation algorithm. In step S520, the determination module 460 determines whether the serial number of the actual label has been stored in the storage unit 20. In step S530, if the serial number of the label has been stored in the storage unit 20, the label is deemed to be adhering to the proper circuit board. In step S540, if the serial number of the label has not been stored in the storage unit 20, the label is deemed to be on an improper circuit board.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A label detecting system comprising:
a display unit;
a capturing unit;
a capture control module to control the capturing unit to capture an image of a circuit board under test, wherein the circuit board under test has a same shape as a standard circuit board;
an image processing module to perform an image processing function for the image of the circuit board under test to obtain a binary image of the circuit board under test;
a scanning module to divide the binary image of the circuit board under test into a number of areas each of which has the same size as that of a binary image of a standard label on the standard circuit board and scan the binary image of the circuit board under test by the binary image of the standard label;
a matching module to perform a generalization and correlation analysis between each area and the binary image of the standard label to obtain a matching value;
a maximum acquiring module to acquire a maximum from all matching values and location information of an area associated with the maximum on the circuit board under test;
a determination module to determine whether the location information of the area associated with the maximum is similar to that of the standard label in the binary image of the standard circuit board and compare the maximum with two threshold values to obtain a result of the determination when the location information of the area associated with the maximum is similar to that of the standard label; and
an output control module to control the display unit to display the result of the determination.

2. The label detecting system as recited in claim 1, wherein the image processing module is configured to perform a gray processing function for the image of the circuit board under test to obtain a gray image and further perform an adaptive binary processing function for the gray image to obtain the binary image of the circuit board under test.

3. The label detecting system as recited in claim 1, wherein the output control module is further configured to output a prompt or warning when the location information of the area associated with the maximum is not similar to that of the standard label and control the display unit to display the prompt or warning which notices a user that a label on the circuit board under test is not adhered to a proper position or the circuit board under test is not labeled.

4. The label detecting system as recited in claim 1, wherein when the maximum is greater than a first threshold value of the two threshold values, the result of the determination comprises that the circuit board under test is properly labeled and a label is properly adhered to the circuit board under test, when the maximum is between the two threshold values, the result of the determination comprises that the circuit board under test is improperly labeled, and when the maximum is less than a second threshold value of the two threshold values, the result of the determination comprises that the circuit board under test is not labeled.

5. The label detecting system as recited in claim 4, wherein the label detecting system stores a plurality of serial numbers of a set of labels including the standard label and each serial number corresponds to a circuit board under test, when the maximum is greater than the first threshold value, the image processing module is further configured to perform a gray and binary processing function for the image of the label on the circuit board under test to obtain a binary image of the label and obtain a serial number of the label via a string segmentation algorithm, the determination module is further configured to determine whether the serial number of the label has been stored in the storage unit, thereby determining whether the label is adhered to a proper circuit board.

6. The label detecting system as recited in claim 1, further comprising a matrix defining module to define a two-dimensional matrix according to the binary image of the circuit board under test and the binary image of the standard label, wherein a column N of the two-dimensional matrix is obtained according to a formula: N=N2−N1+1, where N2 represents a column of the binary image of the circuit board under test and N1 represents a column of the binary image of the standard label, and a row M of the two-dimensional matrix is obtained according to a formula: M=M2−M1+1, where M2 represents a row of the binary image of the circuit board under test and M1 represents a row of the binary image of the standard label, the matching module is further configured to distribute all matching values in the defined two-dimensional matrix, and the maximum acquiring module is further configured to acquire location information of the area associated with the maximum on the circuit board under test in the defined two-dimensional matrix.

7. A label detecting apparatus connecting with a display unit and a capturing unit, wherein the capturing unit is configured to capture an image, the label detecting apparatus comprising:
a capture control module to control the capturing unit to capture an image of the circuit board under test, wherein the circuit board under test has a same shape as a standard circuit board;
an image processing module to perform an image processing function for the image of the circuit board under test to obtain a binary image of the circuit board under test;
a scanning module to divide the binary image of the circuit board under test into a number of areas each of which has the same size as that of a binary image of a standard label on the standard circuit board and scan the binary image of the circuit board under test by the binary image of the standard label;
a matching module to perform a generalization and correlation analysis between each area and the binary image of the standard label to obtain a matching value;
a maximum acquiring module to acquire a maximum from all matching values and location information of an area associated with the maximum on the circuit board under test;
a determination module to determine whether the location information of the area associated with the maximum is similar to that of the standard label in the binary image of the standard circuit board and compare the maximum with two threshold values to obtain a result of the determination when the location information of the area associated with the maximum is similar to that of the standard label; and
an output control module to control the display unit to display the result of the detection.

8. The label detecting apparatus as recited in claim 7, wherein the image processing module is configured to perform a gray processing function for the image of the circuit board under test to obtain a gray image and further perform an adaptive binary processing function for the gray image to obtain the binary image of the circuit board under test.

9. The label detecting apparatus as recited in claim 7, wherein the output control module is further configured to output a prompt or warning when the location information of the area associated with the maximum is not similar to that of the standard label and control the display unit to display the prompt or warning which notices a user that a label on the circuit board under test is not adhered to a proper position or the circuit board under test is not labeled.

10. The label detecting apparatus as recited in claim 7, wherein when the maximum is greater than a first threshold value of the two threshold values, the result of the determination comprises that the circuit board under test is properly labeled and a label is properly adhered to the circuit board under test, when the maximum is between the two threshold values, the result of the determination comprises that the circuit board under test is improperly labeled, and when the maximum is less than a second threshold value of the two threshold values, the result of the determination comprises that the circuit board under test is not labeled.

11. The label detecting apparatus as recited in claim 10, wherein the label detecting apparatus stores a plurality of serial numbers of a set of labels including the standard label and each serial number corresponds to a circuit board under test, when the maximum is greater than the first threshold value, the image processing module is further configured to perform a gray and binary processing function for the image of the label on the circuit board under test to obtain a binary image of the label and obtain a serial number of the label via a string segmentation algorithm, the determination module is further configured to determine whether the serial number of the label has been stored in the storage unit, thereby determining whether the label is adhered to a proper circuit board.

12. The label detecting apparatus as recited in claim 7, further comprising an matrix defining module to define a two-dimensional matrix according to the binary image of the circuit board under test and the stored binary image of the standard label, wherein a column N of the two-dimensional matrix is obtained according to a formula: N=N2−N1+1, where N2 represents a column of the binary image of the circuit board under test and N1 represents a column of the binary image of the standard label, and a row M of the two-dimensional matrix is obtained according to a formula: M=M2−M1+1, where M2 represents a row of the binary image of the circuit board under test and M1 represents a row of the binary image of the standard label, the matching module is further configured to distribute all matching values in the defined two-dimensional matrix, and the maximum acquiring module is further configured to acquire location information of the area associated with the maximum on the circuit board under test in the defined two-dimensional matrix.

13. A detecting label method for a label detecting system, the detecting label method comprising:
capturing an image of a circuit board under test, wherein the circuit board under test has a same shape as a standard circuit board;
performing an image processing function for the image of the circuit board under test to obtain a binary image of the circuit board under test;
dividing the binary image of the circuit board under test into a number of areas each of which has the same size as that of a binary image of a standard label on the standard circuit board and scanning the binary image of the circuit board under test by the binary image of the standard label;
performing a generalization and correlation analysis between each area and the binary image of the standard label to obtain a matching value;
acquiring a maximum from all matching values and location information of an area associated with the maximum on the circuit board under test;
comparing the maximum with two threshold values to obtain a result of the determination when the location information of the area associated with the maximum is similar to that of the standard label; and
displaying the result of the determination.

14. The detecting label method as recited in claim 13, the step “performing an image processing function for the image of the circuit board under test to obtain a binary image of the circuit board under test” comprising:
performing a gray processing function for the image of the circuit board under test to obtain a gray image; and
performing an adaptive binary processing function for the gray image to obtain the binary image of the circuit board under test.

15. The detecting label method as recited in claim 13, further comprising:
outputting a prompt or warning when the location information of the label is not similar to that of the standard label and displaying the prompt or warning which notices a user that a label on the circuit board under test is not adhered to a proper position or the circuit board under test is not labeled.

16. The detecting label method as recited in claim 13, wherein when the maximum is greater than a first threshold value of the two threshold values, the result of the determination comprises that the circuit board under test is properly labeled and a label is properly adhered to the circuit board under test, when the maximum is between the two threshold values, the result of the determination comprises that the circuit board under test is improperly labeled, and when the maximum is less than a second threshold value of the two threshold values, the result of the determination comprises that the circuit board under test is not labeled.

17. The detecting label method as recited in claim 16, wherein the label detecting system further stores a plurality of serial numbers of a set of labels including the standard label and each serial number corresponds to a circuit board under test, the detecting label method further comprising:
performing a gray and binary processing function for the image of the label on the circuit board under test to obtain a binary image of the label when the maximum is greater than the first threshold value;
obtain a serial number of the label via a string segmentation algorithm; and
determining whether the serial number of the label has been stored in the label detecting system, thereby determining whether the label is adhered to a proper circuit board.

18. The detecting label method as recited in claim 13, further comprising:
defining a two-dimensional matrix according to the binary image of the circuit board under test and the stored binary image of a standard label, wherein a column N of the two-dimensional matrix is obtained according to a formula: N=N2-N1+1, where N2 represents a column of the binary image of the circuit board under test and N1 represents a column of the binary image of the standard label, and a row M of the two-dimensional matrix is obtained according to a formula: M=M2-M1+1, where M2 represents a row of the binary image of the circuit board under test and M1 represents a row of the binary image of the standard label;
distributing all matching values in the defined two-dimensional matrix; and
acquiring location information of the area associated with the maximum on the circuit board under test in the defined two-dimensional matrix.
